(19) United States
(12) Patent Application Publication
(10) Pub. No.: US 2024/0119015 A1
(43) Pub. Date: Apr. 11, 2024

(54) INSTRUCTION SET ARCHITECTURE SUPPORT FOR AT-SPEED NEAR-MEMORY ATOMIC OPERATIONS IN A NON-CACHED DISTRIBUTED MEMORY SYSTEM

(71) Applicant: Intel Corporation, Santa Clara, CA (US)

(72) Inventors: Shruti Sharma, Beaverton, OR (US); Robert Pawlowski, Beaverton, OR (US)

(21) Appl. No.: 18/458,462

(22) Filed: Aug. 30, 2023

(51) Int. Cl. G06F 13/16; G06F 9/52

(52) U.S. Cl. CPC G06F 13/1673; G06F 9/526

(57) ABSTRACT

Systems, apparatuses and methods may provide for technology that detects a condition in which a plurality of atomic instructions target a common address and different bit positions in a mask, generates a combined read-lock request for the plurality of atomic instructions in response to the condition, and sends the combined read-lock request to a lock buffer coupled to a memory device associated with the common address.

### GOVERNMENT LICENSE RIGHTS

This invention was made with government support under W911NF22C0081-0108 awarded by the Office of the Director of National Intelligence—AGILE. The government has certain rights in the invention.

### TECHNICAL FIELD

Embodiments generally relate to atomic operations in memory systems. More particularly, embodiments relate to instruction set architecture (ISA) support for at-speed near-memory atomic operations in non-cached distributed memory systems.

### BACKGROUND

Recent developments may have been made in the use of bitmaps, a direct memory access (DMA) instruction set architecture (ISA) and a distributed memory system in artificial intelligence (AI) computations. These solutions may include near-memory compute units capable of executing bitwise operations (e.g., with input masks) atomically between the source and destination data for each element in the DMA operation. There remains considerable room for improvement, however, with respect to the atomic operations in terms of efficiency and/or performance.

### BRIEF DESCRIPTION OF THE DRAWINGS

The various advantages of the embodiments will become apparent to one skilled in the art by reading the following specification and appended claims, and by referencing the following drawings, in which:

FIG. 1A is a slice diagram of an example of a memory system according to an embodiment;

FIG. 1B is a tile diagram of an example of a memory system according to an embodiment;

FIG. 2 is a block diagram of an example of an atomic unit (ATMU) according to an embodiment;

FIG. 3 is a state machine diagram of an example of a non-matched instruction request flow according to an embodiment;

FIG. 4 is a state machine diagram of an example of a matched instruction request flow according to an embodiment;

FIG. 5A is a flowchart of an example of a method of issuing combined read-lock requests according to an embodiment;

FIG. 5B is a flowchart of an example of a method of executing atomic instructions according to an embodiment;

FIG. 5C is a flowchart of an example of a method of issuing combined write-unlock requests according to an embodiment;

FIG. 5D is a flowchart of an example of a method of issuing combined store-with-acknowledgement requests according to an embodiment;

FIG. 5E is a flowchart of an example of a method of handling negative acknowledgements according to an embodiment;

FIG. 6 is a block diagram of an example of a performance-enhanced computing system according to an embodiment;

FIG. 7 is an illustration of an example of a semiconductor package apparatus according to an embodiment;

FIG. 8 is a block diagram of an example of a processor according to an embodiment; and

FIG. 9 is a block diagram of an example of a multi-processor based computing system according to an embodiment.

### DETAILED DESCRIPTION

Bitmaps are commonly used in software to represent sets of integers. Bitmap manipulation operations map directly to set operations on the represented integer sets. An integer i belonging to a set S corresponds to the i-th bit in the string of bits S_{REP} representing S. For example, the intersection of two sets S and S′ is represented by the bitwise AND of their representations S_{REP} and S_{REP}′ and their union by the bitwise OR of the representations.

Bitmaps are also used as masks in certain vectorized instruction sets, to specify to which elements of a vector an instruction applies. In some cases, mask (e.g., bitmap) manipulation instructions are part of the instruction set. While these masks are of length limited by the width of the vector size, a similar mechanism may be applicable to direct memory access (DMA) based bitmap manipulation operations.

Prior hardware approaches to performing atomic operations may involve the use of load linked and store conditional instructions to monitor the memory location under operation. In such solutions, the memory address is first placed in a link register when the load linked instruction is called. Then, if the cache line is invalidated or an interrupt is triggered, the link register is cleared. Once the store conditional operation occurs at the end of the atomic operation, the link register is checked. If the linked register has changed, the store will fail, and an atomic read-modify-write operation will be retried.

This approach may be suitable when the memory location is cached in a coherent domain, and the line can be monitored in the local cache for invalidations. Large-scale systems, however, with limited (or software managed) coherency typically require alternative line-lock monitoring approaches. Additionally, the added latency of the coherency protocol limits the total performance of these operations, especially under scenarios with high contention. Thus, these cache-based and coherency-dependent solutions are performance limited due to the added latency of the coherency protocol. This limitation grows as the rate of address contention increases. Additionally, these solutions have limited scalability in large systems where cache coherency across many sockets and racks becomes less feasible and the latency of remote accesses grows (e.g., necessitating that the remote memory access is made only once).

Other efforts to implement Remote Atomic Operations (RAO) within a last level cache (LLC) or in a memory controller may provide instruction-level support for both posted and non-posted operations. While these efforts may perform the execution and atomic lock handling at distributed home agents within the coherent domain, they may lack an extensive ISA set and specific options and features within the instruction. These efforts may also lack a full architectural approach from pipeline to memory.

The technology described herein incorporates the usage of atomic operations as a part of a larger DMA subsystem—essentially executing compute operations on many data elements triggered by a single DMA ISA. More particularly, embodiments provide ISA and architectural support for remote atomic bit manipulation operations in a distributed memory system (e.g., Transactional Integrated Global-memory system with Dynamic Routing and End-to-end flow control/TIGRE) system. The technology described herein provides for instructions that can be both ISA initiated from the pipeline and requested by a DMA subsystem, pipeline handling of these offloaded operations, and an enhanced design of the atomic unit (ATMU) and line-lock manager near each memory (e.g., dynamic random access memory/DRAM, scratchpad, and model specific register/MSR) interface.

Support for at-speed remote atomic operations in a non-cached distributed memory system results in significant performance improvements to many sparse workloads. When utilized within the context of a wider DMA bitmap manipulation operation, a remote atomic unit maintains high throughput of the near-memory compute operations and aids in reducing total latency for each element within the DMA.

Implementing bitmap operations on the TIGRE system involves a subsystem including pipeline-local DMA engines and near-memory compute at all endpoints in the system. Additionally, an atomic lock buffer positioned adjacent to the memory is implemented to facilitate remote atomic lock/unlock operations involved in the DMA bit manipulation operations.

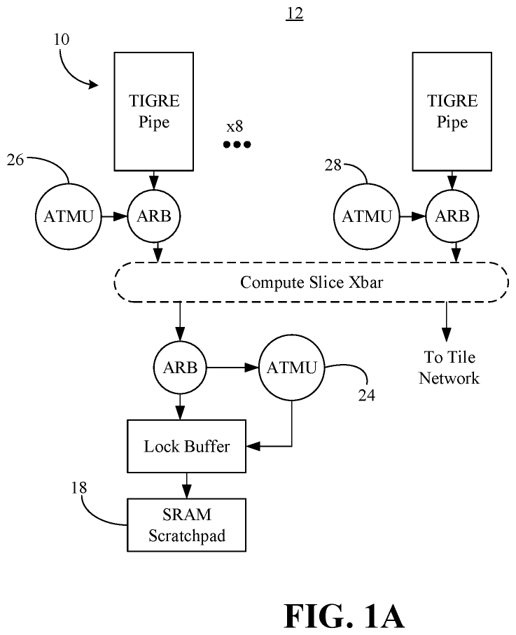

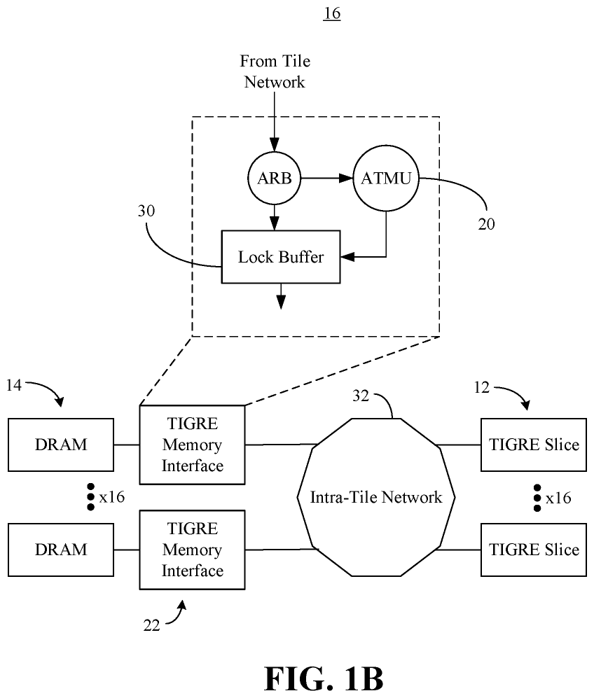

Turning now to FIGS. 1A and 1B, a TIGRE system is a 64-bit Distributed Global Address Space (DGAS) system solution for mixed-mode (e.g., sparse and dense) analytics at scale. Storage in the TIGRE system includes static random access memory (SRAM) scratchpad 18 shared across eight pipelines 10 in a TIGRE slice 12 and sixteen DRAM channels 14 that are part of a TIGRE tile 16. As the system scales out, multiple tiles 16 comprise a TIGRE socket, and the socket count increases to expand the full system.

In an embodiment, a TIGRE system uses a remote-atomic ISA to implement at-speed near memory atomic operations. Implementing remote-atomic operations in the TIGRE system involves the use of atomic units (ATMUs, e.g., engines) 20 within memory interfaces 22 of the TIGRE tile 16 and ATMUs 24, 26, 28 within the TIGRE slices 12. The ATMUs 24, 26, 28 illustrated in the TIGRE slice 12 of FIG. 1A operate similarly to the ATMU 20 illustrated in the TIGRE tile 16 of FIG. 1B. FIGS. 1A and 1B show the lowest levels of the hierarchy of the TIGRE system. Each TIGRE pipeline 10 sends a remote atomic instruction (e.g., exposed in the ISA) to an ATMU 20 located near the targeted memory endpoint. Additionally, the ATMUs 20 can also receive remote-atomic instructions as part of DMA operations, if the DMA involves an optional atomic operation.

The ATMUs 20 handle the execution of the atomic operation next to the memory interfaces 22. Each ATMU 20 includes an integer and floating-point unit and supports multiple instructions in parallel (e.g., dependent on the local memory latency) to maintain relatively high throughput.

Lock buffers 30 maintain line-lock statuses for memory addresses behind the scratchpad 18 or DRAM channel 14 ports. The lock buffer illustrated in the TIGRE slice 12 of FIG. 1A operates similarly to the lock buffer 30 illustrated in the TIGRE tile 16 of FIG. 1B. Each lock buffer 30 is a multi-entry buffer that allows for multiple locked addresses in parallel per memory interface 22, supports 64B (Byte) or 8B requests, handles partial line updates and write-combining for partial stores, and supports “read-lock” and “write-unlock” requests within atomic operations (“atomics”).

The TIGRE system implements atomic operations (e.g., add, increment, decrement, bitop, max, min, etc.). TIGRE also implements masked bit-atomic instructions. The ATMU can receive bit-atomic instructions (e.g., at a bit-level granularity) directly from the TIGRE pipelines 10 through an ISA instruction or as part of a DMA instruction. Table I below describes the bit-atomic ISA instruction, and Table II describes the opcodes used for bit-atomic instructions. Note that when used within the DMA subsystem, a DMA engine will form an identical packet to what the pipelines 10 would form for a targeted remote atomic instruction. Therefore, the instruction inputs described below are fully constructed for the iteration of each element of a DMA operation.

TABLE I

| ISA Instruction | ASM for arguments |
|---|---|
| xbit-atomic | R1 = Target Address, R2 = Result address, R3 = Mask |
| r1, r2, r3, r4, | value to specify Bit position in the target address that |
| opcode | needs to be replaced, R4 = src bit value; Opcode = |
| | ATMU Opcode |

TABLE II

| Opcode | Operation to Perform |
|---|---|
| 3′b000 : | For(I = 0 to 63) { //64 bits in 1 word |
| NONE | Mem[target_address][i] = (mask[i] == 0) ? |
| | mem[target_address][i] : src_bit; } |
| 3′b001 : | For(I = 0 to 63) { //64 bits in 1 word |
| OR | Mem[target_address] = (mask[i] == 0) ? |
| | mem[target_address][i] : (src_bit \|mem[target_address][i]); } |
| 3′b010 : | For(I = 0 to 63) { //64 bits in 1 word |
| AND | Mem[target_address] = (mask[i] == 0) ? |
| | mem[target_address][i] : (src_bit & mem[target_address][i]); } |
| 3′b011 : | For(I = 0 to 63) { //64 bits in 1 word |
| XOR | Mem[target_address] = (mask[i] == 0) ? |
| | mem[target_address][i] : (src_bit \hat{ } mem[target_address][i]); } |
| 3′b100 : | For(I = 0 to 63) { //64 bits in 1 word |
| TEST | Mem[target_address] = (mask[i] == 0) ? |
| AND | mem[target_address][i] : ((mem[target_address][i] == 0) |
| | ? src_bit : mem[target_address][i] )); |
| SET | mem[Result_address][i] = mem[target_address][i]; //return |
| | old bit value in result address |
| 3′b101 | Reserved |
| 3′b110 | Reserved |
| 3′b111 | Reserved |

Remote Atomic Architecture—Near Memory Atomic Unit

As already noted, the ATMUs 20 are the near memory compute unit that are responsible for executing the atomic operations at the targeted memory endpoint. The ATMUs 20 receive the instruction packets from an intra-tile network 32—regardless of whether the source requestor is a pipeline 10 or a remote DMA engine (not shown). The ATMUs 20 can receive multiple back-to-back requests targeting the same 8-Byte address for bitmap manipulations, which can lead an increase in the number of locked-line negative acknowledgement (“nak”) retries that the lock buffer 30 returns to the ATMU 20. As the number of nak retries increases, the retry requests can begin to interfere with other traffic to and from the memory. Nak retries also introduce more delay within the ATMU 20 as nak retried requests typically take preference over other requests.

One potential solution to avoid the increase in the number of nak retries is by blocking the read requests targeting the same 8-Byte Address. The blocking requests are easier to implement but can lead to decreased performance as the new instructions wait for the old instruction completion and write back before being processed. To avoid declining impact on performance, the ATMU 20 combines the execution of multiple instructions using address and mask match logic. Only single read-lock and write-unlock requests are sent to local memory for the combined-instructions, which reduces the number of nak retries. Combining the execution also enables non-blocking instruction execution within the ATMU 20, maintaining higher request-response rates out of the ATMU 20.

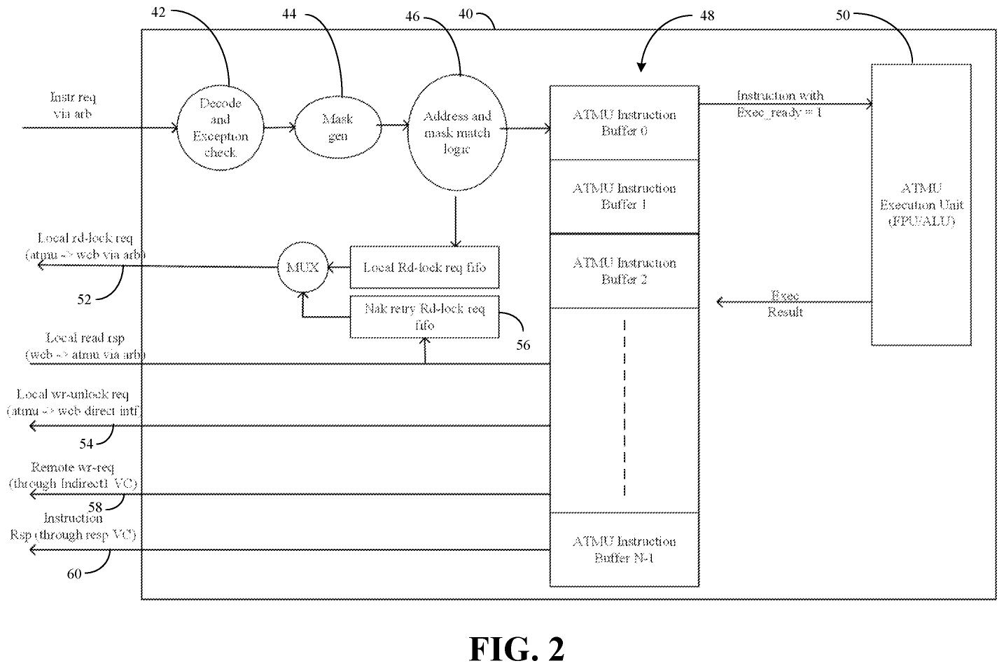

FIG. 2 shows an ATMU 40 that may be readily substituted for the ATMU 20 (FIG. 1B), already discussed. The following operations explain the instruction execution flow within the ATMU 40:
The ATMU 40 decodes the instruction in a decode stage 42 (e.g., including exception check functionality), and the decoded instruction is passed through a mask generation stage 44. The generated mask value specifies the bits in the 8-byte word that are to be modified atomically.
Following the decode and mask generation, the instruction passes through a mask-match and address-match stage 46 to find other instructions in an ATMU instruction buffer 48 that have a matching address and satisfy a non-overlapping mask-check requirement.
After the mask-match and address-match stage 46, the atomic instruction is stored in a slot of the ATMU instruction buffer 48. Each slot in the instruction buffer 48 stores the information on the address and mask match outcome, along with the slot identifier (id) of the matched slot.
A read-lock request is then sent to memory if there are no other previous instructions in the ATMU instruction buffer 48 that satisfied the address and mask-match requirement.
If there is a matching slot, no separate read-lock request is sent to memory for the current instruction. Rather, a combined read-lock request is sent from the “matching slot” for multiple “matched-instructions”.
The lock buffer 30 (FIG. 1B) returns data as part of a read-lock request. The address remains locked in the lock buffer 30 (FIG. 1B).
Once the read data arrives, the instructions are prepared for execution. For non-matching instructions, the execution is conducted independently. If the instruction has a matching slot, execution of the instruction is combined with multiple other “matched-instructions”. The instruction execution is conducted using an arithmetic logic unit (ALU) and/or floating point unit (FPU) within an execution unit 50 of the ATMU 40.
The result of the operation is committed back to memory through the lock buffer 30 (FIG. 1B) using a write-unlock request. The matched instructions send a single combined write-unlock request to the lock buffer 30 (FIG. 1B). For instructions that do not have any matching slot, a separate write-unlock request is sent to the lock buffer 30 (FIG. 1B).
If the matched instructions are associated with a result update requirement (e.g., for bit-atomic instructions), a combined store-with-ack request is sent from the matching slot to the result address.
At this juncture, the atomic operation is complete. The completed instructions in the buffer 48 send an instruction response back to the source to indicate the instruction completion. If the matching slot previously sent a store-with-ack request to the result address, no instruction response is conducted for that slot.

Interface

The ATMU 40 can support the highest throughput possible for remote atomics. Because the remote atomic requests in TIGRE can arrive at the ATMU 40 at a rate of one per cycle, the ATMU 40 also supports the execution of one operation per cycle. More particularly, the interface of the ATMU 40 includes the following features:

Two Separate Local Ports for Read-Lock and Write-Unlock Requests

There are two memory accesses per atomic operation, which creates a bottleneck at a single port into the local memory channel. This bottleneck in turn creates additional latency per operation when there are multiple execution threads contending for the port for both reads and writes. To account for this bottleneck, a separate read port 52 and write port 54 are used to maintain the 8 GB/s/op (eight GigaBytes per second per operation) throughput. The lock buffer supports two ATMU ports for read-lock and write-unlock requests.

Priority Ordering of Nack-Retried Requests Based on Retry-Index Value

Ordering of memory accesses is guaranteed once the requests arrive at the destination memory interface. To support this expectation, when an address is locked and a subsequent access is made to that locked address, the lock buffer returns a “retry-index” value to the ATMU 40 (e.g., the requestor). Once the line is unlocked, the retried requests to that address are accepted based on the order in which they originally attempted to access the address. To preserve the bandwidth available over the ports 52, 54 from the ATMU 40, only retries that have the highest probability of success are issued. Therefore, the ATMU 40 is designed to account for the priority of the retry index value when issuing the retried requests. In the illustrated example, retries of combined read-lock requests are prioritized through a FIFO (first in first out) buffer 56.

Separate Port for Remote Write Requests

Bit-atomic requests from a pipeline or DMA engine might be associated with a result address update requirement along with the atomic operation on the target address. Unlike target addresses, result addresses do not involve atomic updates, and a simple store with ack request can be sent out of the ATMU 40 to update the result value. The result address might or might not belong to same local memory, hence the write request for result address is always passed through the network and is sent via a dedicated port 58 as a remote write request. For instructions requiring result update, the ATMU 40 does not send an instruction response. Rather, the instruction response is sent by the memory endpoint after the store request for result address is serviced.

Separate Port for Instruction Responses

For instructions that do not require a result update, the instruction response is sent back to the originator (e.g., pipeline or DMA engine) after the write-unlock completes. In such a case, a separate port 60 for instruction response is used to maintain the 8 GB/s/op expectation.

Decode and Mask Generation

The ATMU 40 can support atomic operations and bitmap manipulation operations. For bit-atomic DMA operations, the ATMU can receive back-to-back atomic instructions to manipulate different bits within the same 8B word. For atomic operations other than bitmap manipulation, the ATMU supports 8B and sub-8B operations with size 1B, 2B and 4B. The ATMU 40 can receive multiple instructions targeting the same 8B word in memory but modifying different bytes within the same 8B word. In such a case, combined execution can be performed by issuing one single read-lock request, a single request to the execution unit 50, and a single write-unlock request. This approach significantly reduces the number of nack-retries and enables the ATMU to support the highest throughput possible.

The decode stage 42 extracts the address, size, data, and opcode information from the instruction packet and sends the information to the mask generation stage 44 to generate the mask. The mask generation stage 44 specifies what byte within the 8-byte is to be updated. Mask generation is used for non-bit-atomic instructions. For bit-atomic instructions, the mask value comes as part of instruction packet. The mask value is generated by mask generation logic as shown below.

// mask generation logic
bit_32 = ‘hffff_ffff;
bit_16 = ‘hffff;
bit_8 = ‘hff;
if(size == 8Byte) { mask_value = 64’(hffff_ffff_ffff_ffff);}
else if(size == 4Byte) { mask_value = 64’(bit_32 << (addr[2:0] * 8));}
else if(size == 2Byte) { mask_value = 64’(bit_16 << (addr[2:0] * 8));}
else if(size == 1Byte) { mask_value = 64’(bit_8 << (addr[2:0] * 8)); }

As already noted, the ATMU 40 does not use the mask generation stage 44 for bit-atomic instructions. Rather, the mask value specifying the bit to manipulate is received as part of the instruction packet. The final mask value is then sent to the mask-match and address-match stage 46 to detect the instructions that have a non-overlapping mask, the same 8-byte address, and the same opcode value.

Address and Mask Match

For the incoming ATMU instructions, the mask-match and address-match stage 46 performs the operation as specified below.

```
  //address and mask match logic
  for(int i = 0; i < NUM_ATMU_SLOTS; i++) {
    if(valid[i] & !matched_bit[i] & !exec_ready[i]
    !(|(current_mask & instruction_mask[i])) &
    (current_tar_addr[63:3] == instruction_tar_addr[i][63:3])){
      matched = 1;
      matching_slot_id = i;
      break;
    }
  }
  instruction_mask[matching_slot_id] = current_mask |
instruction_mask[matching_slot_id];
```

Corresponding to the mask-match and address-match stage 46, every instruction slot in the instruction buffer 48 has a 1-bit field specifying whether the instruction has a previous matching instruction in the buffer 48 (e.g., matched bit), a 1-bit field specifying whether the instruction is ready for execution (exec_ready), a field to store the slot id of the matching slot, a 64-bit field specifying the mask value, a 64-bit field specifying the target address value, and a 64-bit field specifying the result address value. When a new instruction arrives, the following operations are conducted by the mask-match and address-match stage 46:
The incoming instruction mask and address value is compared against the mask and address value of every valid slot that has matched bit=0, and the same opcode value.
For mask comparison, the mask value of the current instruction is compared bit-by-bit with the instructions in the instruction buffer 48. A mask match occurs when all the bits in the two mask values are non-overlapping (e.g., the corresponding bits in the two mask values are not both one).
For address comparison, the 8-byte aligned target address is compared with the target address of the instruction slot. For bit-atomic instructions, the result address is also equal to be considered an address match.
If the new instruction finds a matching instruction within the instruction buffer 48, the new instruction is placed in an empty slot in the buffer 48 with matched bit=1, and matching id=slot id of the matching instruction slot.
For the matching slot, the mask value is updated to accommodate new instruction mask values by performing an “OR” between the two mask values.

Instruction Buffer

The instruction buffer 48 is used to track the instruction flow within the ATMU 40. The storage breakdown of a single entity within the instruction buffer 48 is shown in Table III.

TABLE III

| Name | Description | Width(bits) |
|---|---|---|
| Valid | Valid = 1 specifies that the slot is | 1 |
| | taken. Valid = 0 specifies slot is | |
| | empty | |
| Matched_bit | Matched_bit = 1 specifies that the | 1 |
| | instruction has matching address and | |
| | mask with another instruction in the | |
| | buffer | |
| Matching_slot_id | Slot id of the buffer slot which has the | Log2(num_of_slots) |
| | instruction with matching address and | |
| | mask | |
| Exec_ready | This field tells if the instruction is | 1 |
| | ready for execution. Instruction will | |
| | be ready for execution after read data | |
| | is received | |
| Exec_done | This field tells that the execution | 1 |
| | result is ready, and the instruction can | |
| | send a write-unlock request to | |
| | memory | |
| Result_bit | The result bit indicates that the | 1 |
| | instruction should send a store with | |
| | ack request to result address with | |
| | result data value | |
| Resp_bit | The resp_bit specifies that the | 1 |
| | instruction should send an instruction | |
| | response out to network | |
| Instruction_mask | Mask value specifies what bits within | 64 |
| | 8 Byte word atomic instruction needs | |
| | to modify | |
| Dest_address | Target address for atomic operation | 64 |
| Result_address | Result address for bit-atomic | 64 |
| | instructions | |
| Input_data | Input data for performing the atomic | 64 |
| | operation | |
| Exec_data | Data to be stored back into the | 64 |
| | memory as part of write-unlock after | |
| | exec_done | |
| Result_data | Data to be stored to result_address for | 64 |
| | bit-atomic instructions | |
| opcode | Opcode value to specify the atomic | 8 |
| | operation that needs to be performed | |
| Request_id | Request id value received as part of | 8 |
| | instruction packet | |

The request flow for the instruction in the instruction buffer 48 depends on the output of the mask-match and address-match stage 46.

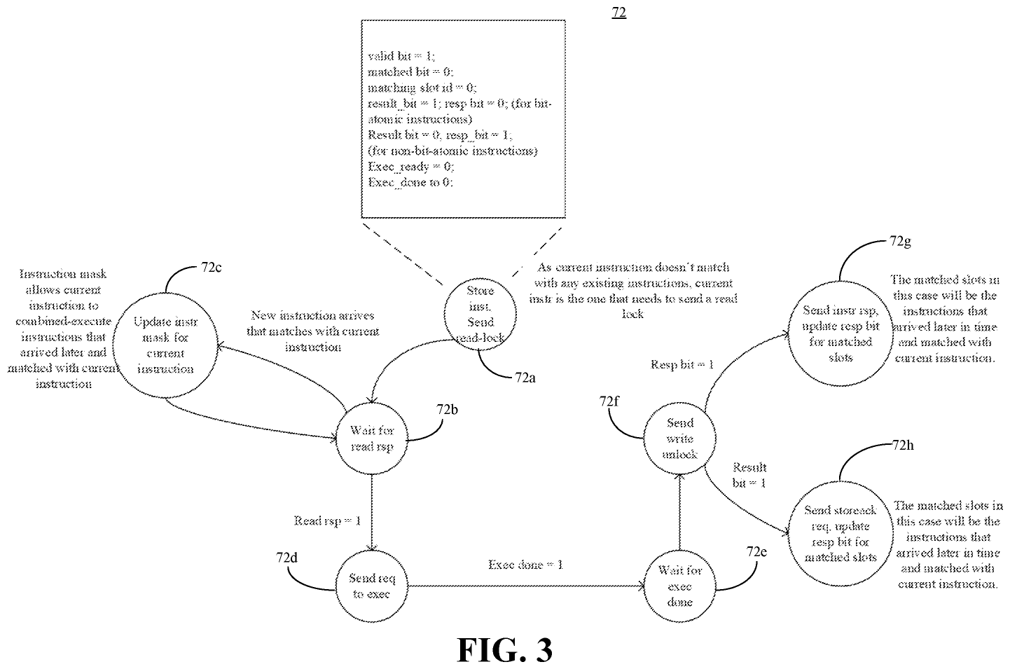

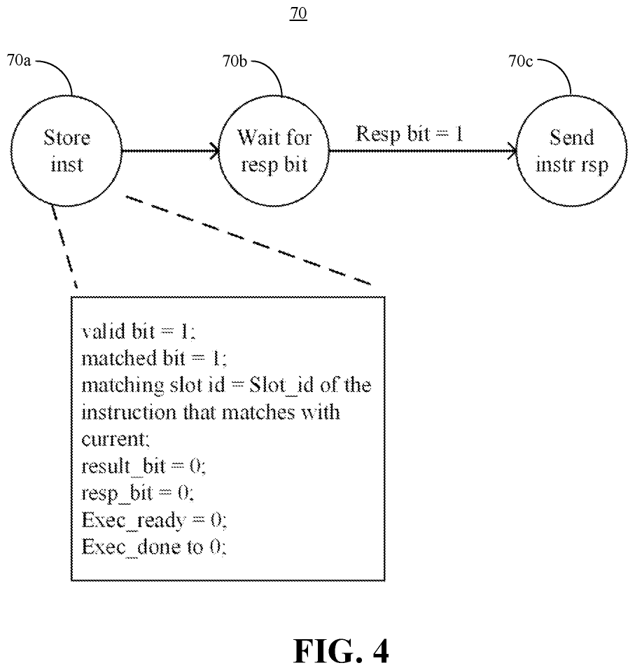

FIGS. 3 and 4 show a request flow state machine 72 (72a-72h) for instructions that do not match with any existing instructions and a request flow state machine 70 (70a-70c) for matched instructions, respectively. The request flow for both the scenarios is explained in detail below.

Instruction does not Match with any Existing Instructions in the Buffer
In state 72a, store the instruction in an empty buffer slot, mark the valid bit=1, matched bit=0, matching slot id=0. Mark result_bit=0, resp_bit=1 for non-bit-atomic instructions. Mark result_bit=1, resp_bit=0 for bit-atomic instructions. Reset Exec_ready, Exec_done to 0. Update instruction_mask with mask_value generated from mask generation logic. Also update Result_address, dest_address, opcode, Input_data, Request_id information and put the slot_id of the buffer slot in the read-lock request fifo (first in first out) buffer.
In state 72b, wait for read data from memory.
When the current instruction reached the ATMU, the instruction did not match with any existing instructions. But later in time, new instructions might arrive that match with current instruction. Since the current instruction was the first to arrive at the ATMU without a match to any existing instructions, the current instruction will be responsible for sending the read-lock request, and updating the corresponding instruction mask in state 72c if any new instruction arrives that matches with current instruction. The instruction mask will then be used to perform combined execution of the current instruction and new instructions.
In state 72d, mark exec_ready=1 when read a response is received and send the request to ATMU execution unit for floating point/integer (“int”) computation.
In state 72e, wait for the execution unit data. Update exec_done=1 when the execution unit sends the data back and update exec_data value. Update result_data in for bit-atomic instructions.
In state 72f, send the write-unlock request to memory from the current slot. Update other instructions in the buffer that have matched_bit=1, and matching_slot_id=current_slot_id to mark resp_bit=1 for other slots.
In state 72g, send the instruction response if resp_bit=1.
In state 72h, send a store-with-ack request with result_data for result_address if result_bit=1.
Finally, invalidate the slot by setting valid=0.

Instruction Matches with an Existing Instruction in the Buffer
In state 70a, store the instruction in an empty buffer slot, mark the valid bit=1, matched bit=1, matching slot id=Slot_id of the instruction that matches with current instruction (output of mask and address match logic). Mark result_bit=0, resp_bit=0. Reset Exec_ready, Exec_done to 0. Also update instruction_mask with mask_value generated from mask generation logic and update Result_address, dest_address, opcode, Input_data, Request_id information.
When the current instruction reached ATMU, it matched with an existing instruction in the instruction buffer. Therefore, the current instruction does not perform any read-lock, execution or write unlock. These operations will be performed by the older instruction that was already present in the ATMU, and to which the current instruction matched. The current instruction merely waits in state 70b for the resp_bit to become 1 and sends the instruction response to the network in state 70c. After the current instruction sends the instruction response to the network, the current instruction can invalidate the slot by setting valid=0.

Execution Unit

In one example, the ATMU execution unit includes a floating-point unit and an integer unit. Both floating point and integer units are pipelined and can support one request and one response per cycle. The ATMU floating point unit can perform floating point add, mul, min and max operations on double precision, single precision and bfloat16 (brain 16-bit floating point) data types. The ATMU integer unit can perform add, mul, max, min and bitwise operations on 1-Byte, 2-Byte, 4-Byte and 8-Byte data. In an embodiment, the ATMU integer unit includes two bitwise-op units to support parallel execution of result data and target data involved in bit-atomic instructions.

Remote Atomic Architecture—Near Memory Lock Buffer

As already noted, a lock buffer is located in front of each memory port. A brief description of the lock buffer is as follows:
Handle line locks for atomic and partial store (sub-8B) operations. Atomic requests are kept locked for the duration of the atomic operation. Partial store requests pull the fully aligned 8B data into the lock buffer before storing the partial write. This approach provides for accommodating the memory controller (MC) generating error correction code (ECC) information at an 8B granularity.
Temporarily store data during the atomic operations for low-latency access during the write-unlock portion. The lock buffer in a programmable integrated unified memory architecture (PIUMA) is not used as a cache, however, and therefore only holds a low number of lines (e.g., enough to cover the latency to the local memory and allow for multiple concurrent locked lines with no locking of the memory port).
Merge writes for requests targeting data that is already held in the lock buffer. Lines are allocated at a 64B granularity (PIUMA supports both 8B and 64B byte writes (with byte enables).

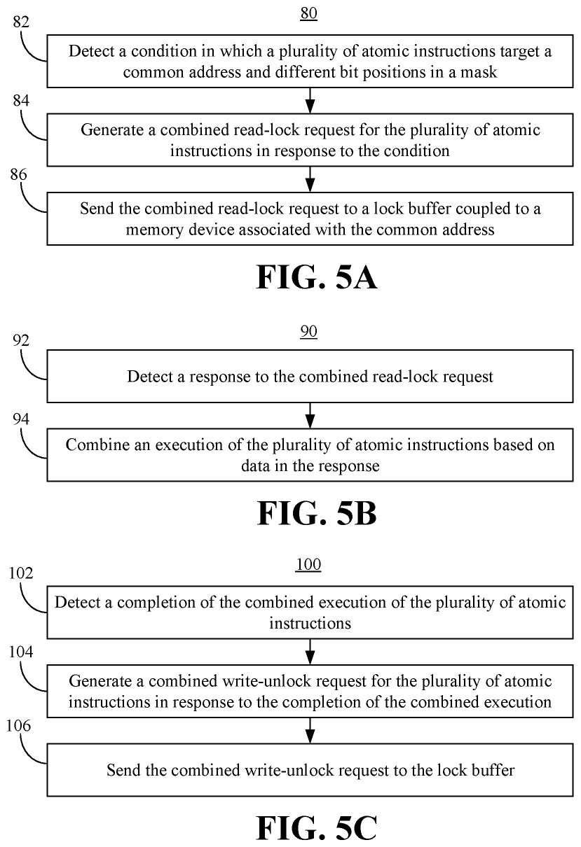

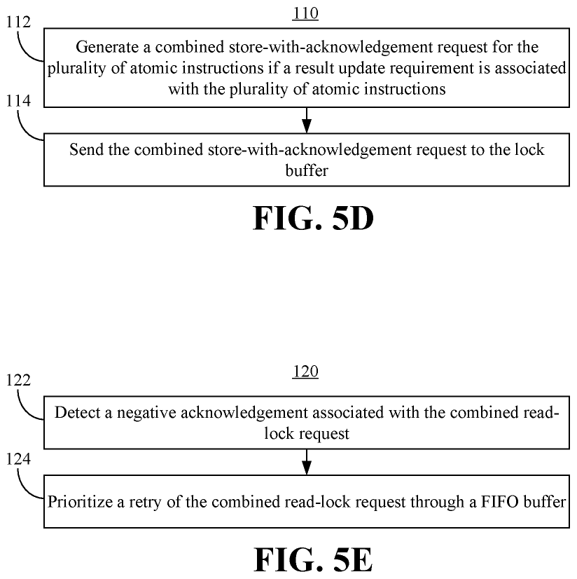

FIG. 5A shows a method 80 of issuing combined read-lock requests. The method 80 may generally be implemented in an ATMU such as, for example, the ATMU 20 (FIG. 1B) and/or the ATMU 40 (FIG. 2), already discussed. More particularly, the method 80 may be implemented in one or more modules as a set of logic instructions (e.g., executable program instructions) stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 80 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 82 provides for detecting a condition in which a plurality of atomic instructions target a common address and different bit positions in a mask. Block 84 generates a combined read-lock request for the plurality of atomic instructions in response to the condition. Additionally, block 86 sends the combined read-lock request to a lock buffer coupled to a memory device associated with the common address. In one example, the memory device is a local memory device and the plurality of atomic instructions originate from a remote source (e.g., pipeline, DMA subsystem) in a distributed memory system. In such a case, the distributed memory system may be a non-cached distributed memory system. The method 80 therefore enhances performance at least to the extent that the combined read-lock request reduces memory traffic and/or latency (e.g., enabling at-speed remote atomic operations), particularly in the presence of sparse workloads and/or a lack of coherency support.

FIG. 5B shows a method 90 of executing atomic instructions. The method 90 may generally be implemented in conjunction with the method 80 (FIG. 5A) in an ATMU such as, for example, the ATMU 20 (FIG. 1B) and/or the ATMU 40 (FIG. 2), already discussed. More particularly, the method 90 may be implemented in one or more modules as a set of logic instructions stored in a machine- or computer-readable storage medium such as RAM, ROM, PROM, firmware, flash memory, etc., in hardware, or any combination thereof.

Illustrated processing block 92 provides for detecting a response to the combined read-lock request. Block 94 combines an execution of the plurality of atomic instructions based on data in the response. The method 90 therefore further enhances performance at least to the extent that the combined execution increases request-response rates out of the atomic unit.

FIG. 5C shows a method 100 of issuing combined write-unlock requests. The method 100 may generally be implemented in conjunction with the method 80 (FIG. 5A) and/or the method 90 (FIG. 5) in an ATMU such as, for example, the ATMU 20 (FIG. 1B) and/or the ATMU 40 (FIG. 2), already discussed. More particularly, the method 100 may be implemented in one or more modules as a set of logic instructions stored in a machine- or computer-readable storage medium such as RAM, ROM, PROM, firmware, flash memory, etc., in hardware, or any combination thereof.

Illustrated processing block 102 provides for detecting a completion of the combined execution of the plurality of atomic instructions, wherein block 104 generates a combined write-unlock request for the plurality of atomic instructions in response to the completion of the combined execution. Block 106 sends the combined write-unlock request to the lock buffer. The method 100 therefore further enhances performance at least to the extent that the combined write-unlock further reduces latency.

FIG. 5D shows a method 110 of issuing store-with-acknowledgement requests. The method 110 may generally be implemented in conjunction with the method 80 (FIG. 5A), the method 90 (FIG. 5B) and/or the method 100 (FIG. 5C) in an ATMU such as, for example, the ATMU 20 (FIG. 1B) and/or the ATMU 40 (FIG. 2), already discussed. More particularly, the method 110 may be implemented in one or more modules as a set of logic instructions stored in a machine- or computer-readable storage medium such as RAM, ROM, PROM, firmware, flash memory, etc., in hardware, or any combination thereof.

Illustrated processing block 112 provides for generating a combined store-with-acknowledgement request for the plurality of atomic instructions if a result update requirement is associated with the plurality of atomic instructions. Block 114 sends the combined store-with-acknowledgement request to the lock buffer. The method 110 therefore further enhances performance at least to the extent that the combined store-with-acknowledgement further reduces latency.

FIG. 5E shows a method 120 of handling negative acknowledgements. The method 120 may generally be implemented in conjunction with the method 80 (FIG. 5A), the method 90 (FIG. 5B), the method 100 (FIG. 5C) and/or the method 110 (FIG. 5D) in an ATMU such as, for example, the ATMU 20 (FIG. 1B) and/or the ATMU 40 (FIG. 2), already discussed. More particularly, the method 110 may be implemented in one or more modules as a set of logic instructions stored in a machine- or computer-readable storage medium such as RAM, ROM, PROM, firmware, flash memory, etc., in hardware, or any combination thereof.

Illustrated processing block 122 detects a negative acknowledgement (nak) associated with the combined read-lock request. Block 124 prioritizes a retry of the combined read-lock request through a FIFO buffer. The method 120 therefore further enhances performance at least to the extent that prioritizing the retry further reduces latency.

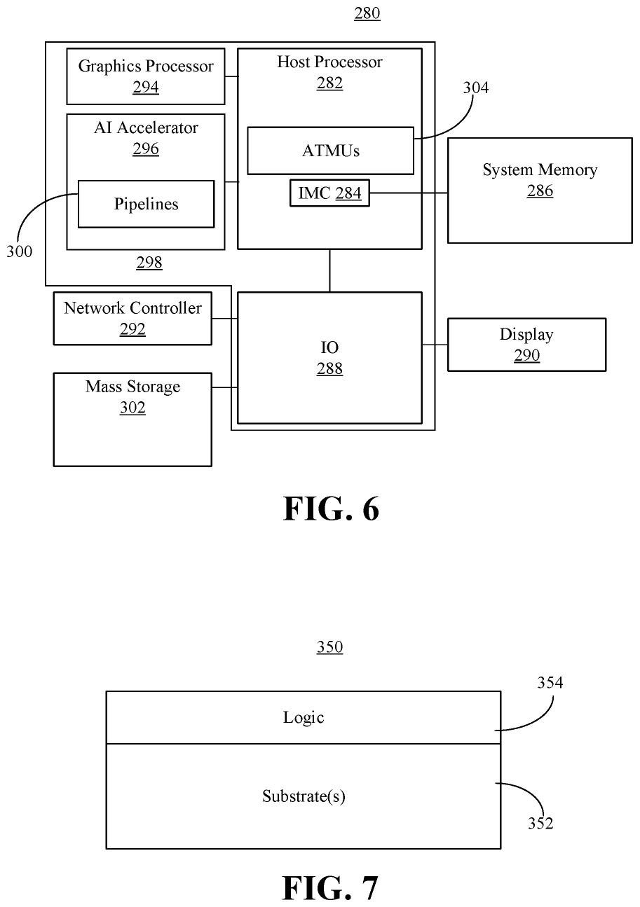

Turning now to FIG. 6, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, drone functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM including a plurality of DRAMs). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 (e.g., specialized processor) into a system on chip (SoC) 298.

In an embodiment, the AI accelerator 296 includes a plurality of pipelines 300 and the host processor 282 includes a plurality of atomic units (ATMUs) 304, wherein the pipelines 300 and ATMUs 304 represent a non-cached distributed memory system. The ATMUs 304 perform one or more aspects of the method 80 (FIG. 5A), the method 90 (FIG. 5B), the method 100 (FIG. 5C), the method 110 (FIG. 5D) and/or the method 120 (FIG. 5E), already discussed. Thus, the ATMUs 304 may detect a condition in which a plurality of atomic instructions target a common address and different bit positions in a mask, generate a combined read-lock request for the plurality of atomic instructions in response to the condition, and send the combined read-lock request to a lock buffer (not shown) coupled to the system memory 286 (e.g., a memory device associated with the common address). The computing system 280 is therefore considered performance-enhanced at least to the extent that the combined read-lock request reduces memory traffic and/or latency (e.g., enabling at-speed remote atomic operations), particularly in the presence of sparse workloads and/or a lack of coherency support.

FIG. 7 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 80 (FIG. 5A), the method 90 (FIG. 5B), the method 100 (FIG. 5C), the method 110 (FIG. 5D) and/or the method 120 (FIG. 5E), already discussed, and may be readily substituted for the ATMUs 304 (FIG. 6), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

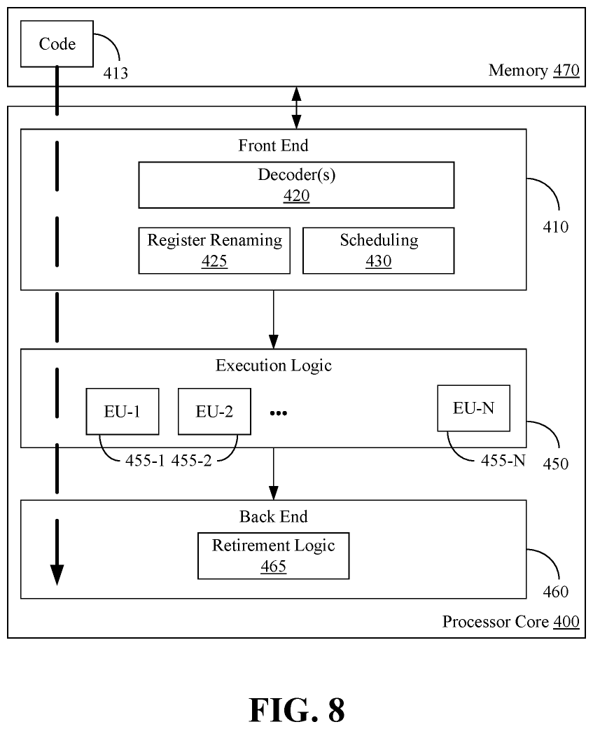

FIG. 8 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 8, a processing element may alternatively include more than one of the processor core 400 illustrated in FIG. 8. The processor core 400 may be a single-threaded core or, for at least one embodiment, the processor core 400 may be multithreaded in that it may include more than one hardware thread context (or “logical processor”) per core.

FIG. 8 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 80 (FIG. 5A), the method 90 (FIG. 5B), the method 100 (FIG. 5C), the method 110 (FIG. 5D) and/or the method 120 (FIG. 5E), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 8, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

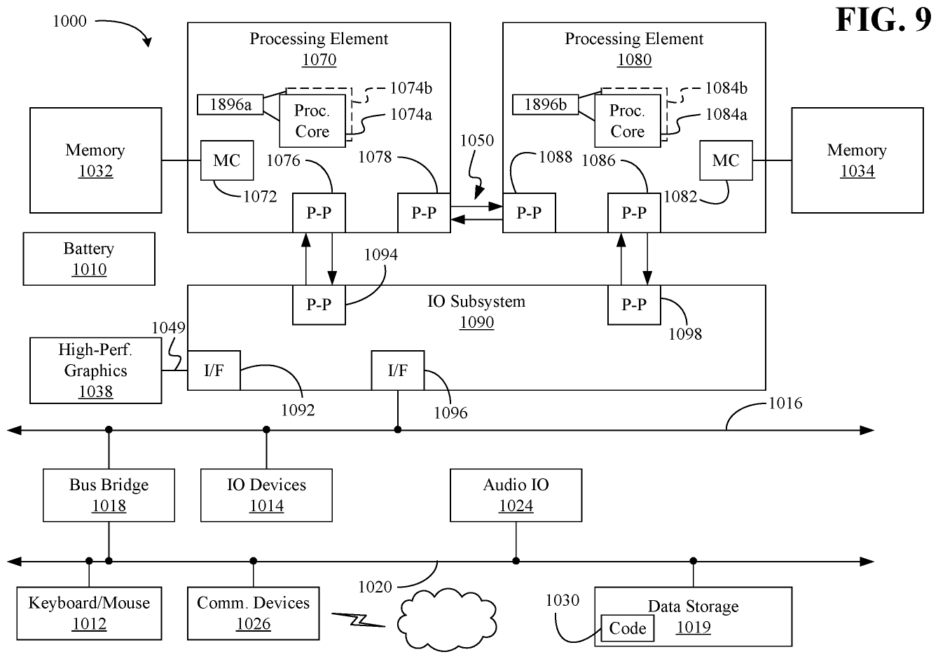

Referring now to FIG. 9, shown is a block diagram of a computing system 1000 embodiment in accordance with an embodiment. Shown in FIG. 9 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 9 may be implemented as a multi-drop bus rather than point-to-point interconnect.

As shown in FIG. 9, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 8.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 9, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 9, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 9, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 80 (FIG. 5A), the method 90 (FIG. 5B), the method 100 (FIG. 5C), the method 110 (FIG. 5D) and/or the method 120 (FIG. 5E), already discussed. Further, an audio I/O 1024 may be coupled to second bus 1020 and a battery 1010 may supply power to the computing system 1000.

Note that other embodiments are contemplated. For example, instead of the point-to-point architecture of FIG. 9, a system may implement a multi-drop bus or another such communication topology. Also, the elements of FIG. 9 may alternatively be partitioned using more or fewer integrated chips than shown in FIG. 9

### ADDITIONAL NOTES AND EXAMPLES

Example 1 includes a performance-enhanced computing system comprising a memory device, a lock buffer coupled to the memory device, and an atomic unit coupled to the lock buffer, wherein the atomic unit includes logic coupled to one or more substrates, the logic to detect a condition in which a plurality of atomic instructions target a common address and different bit positions in a mask, generate a combined read-lock request for the plurality of atomic instructions in response to the condition, and send the combined read-lock request to the lock buffer, wherein the memory device is associated with the common address.

Example 2 includes the computing system of Example 1, wherein the logic is further to detect a response to the combined read-lock request, combine an execution of the plurality of atomic instructions based on data in the response, detect a completion of the combined execution of the plurality of atomic instructions, generate a combined write-unlock request for the plurality of atomic instructions in response to the completion of the combined execution, and send the combined write-unlock request to the lock buffer.

Example 3 includes the computing system of Example 2, wherein the logic is further to generate a combined store-with-acknowledgement request for the plurality of atomic instructions if a result update requirement is associated with the plurality of atomic instructions, and send the combined store-with-acknowledgement request to the lock buffer.

Example 4 includes the computing system of Example 1, wherein the logic is further to detect a negative acknowledgement associated with the combined read-lock request, and prioritize a retry of the combined read-lock request through a first in first out buffer.

Example 5 includes the computing system of any one of Examples 1 to 4, wherein the memory device is a local memory device, the plurality of atomic instructions are to originate from a remote source in a distributed memory system, and the distributed memory system is to be a non-cached distributed memory system.

Example 6 includes at least one computer readable storage medium comprising a set of executable program instructions, which when executed, cause a computing system to detect a condition in which a plurality of atomic instructions target a common address and different bit positions in a mask, generate a combined read-lock request for the plurality of atomic instructions in response to the condition, and send the combined read-lock request to a lock buffer coupled to a memory device associated with the common address.

Example 7 includes the at least one computer readable storage medium of Example 6, wherein the executable program instructions, when executed, further cause the computing system to detect a response to the combined read-lock request, and combine an execution of the plurality of atomic instructions based on data in the response.

Example 8 includes the at least one computer readable storage medium of Example 7, wherein the executable program instructions, when executed, further cause the computing system to detect a completion of the combined execution of the plurality of atomic instructions, generate a combined write-unlock request for the plurality of atomic instructions in response to the completion of the combined execution, and send the combined write-unlock request to the lock buffer.

Example 9 includes the at least one computer readable storage medium of Example 8, wherein the executable program instructions, when executed, further cause the computing system to generate a combined store-with-acknowledgement request for the plurality of atomic instructions if a result update requirement is associated with the plurality of atomic instructions, and send the combined store-with-acknowledgement request to the lock buffer.

Example 10 includes the at least one computer readable storage medium of Example 6, wherein the executable program instructions, when executed, further cause the computing system to detect a negative acknowledgement associated with the combined read-lock request, and prioritize a retry of the combined read-lock request through a first in first out buffer.

Example 11 includes the at least one computer readable storage medium of any one of Examples 6 to 10, wherein the memory device is to be a local memory device and the plurality of atomic instructions are to originate from a remote source in a distributed memory system.

Example 12 includes the at least one computer readable storage medium of Example 11, wherein the distributed memory system is to be a non-cached distributed memory system.

Example 13 includes a semiconductor apparatus comprising one or more substrates, and logic coupled to the one or more substrates, wherein the logic is implemented at least partly in one or more of configurable or fixed-functionality hardware, the logic to detect a condition in which a plurality of atomic instructions target a common address and different bit positions in a mask, generate a combined read-lock request for the plurality of atomic instructions in response to the condition, and send the combined read-lock request to a lock buffer coupled to a memory device associated with the common address.

Example 14 includes the semiconductor apparatus of Example 13, wherein the logic is further to detect a response to the combined read-lock request, and combine an execution of the plurality of atomic instructions based on data in the response.

Example 15 includes the semiconductor apparatus of Example 14, wherein the logic is further to detect a completion of the combined execution of the plurality of atomic instructions, generate a combined write-unlock request for the plurality of atomic instructions in response to the completion of the combined execution, and send the combined write-unlock request to the lock buffer.

Example 16 includes the semiconductor apparatus of Example 15, wherein the logic is further to generate a combined store-with-acknowledgement request for the plurality of atomic instructions if a result update requirement is associated with the plurality of atomic instructions, and send the combined store-with-acknowledgement request to the lock buffer.

Example 17 includes the semiconductor apparatus of Example 13, wherein the logic is further to detect a negative acknowledgement associated with the combined read-lock request, and prioritize a retry of the combined read-lock request through a first in first out buffer.

Example 18 includes the semiconductor apparatus of any one of Examples 13 to 17, wherein the memory device is to be a local memory device and the plurality of atomic instructions are to originate from a remote source in a distributed memory system.

Example 19 includes the semiconductor apparatus of Example 18, wherein the distributed memory system is to be a non-cached distributed memory system.

Example 20 includes the semiconductor apparatus of any one of Examples 13 to 19, wherein the logic coupled to the one or more substrates includes transistor channel regions that are positioned within the one or more substrates.

Example 21 includes a method of operating a performance-enhanced computing system, the method comprising detecting a condition in which a plurality of atomic instructions target a common address and different bit positions in a mask, generating a combined read-lock request for the plurality of atomic instructions in response to the condition, and sending the combined read-lock request to a lock buffer coupled to a memory device associated with the common address.

Example 22 includes an apparatus comprising means for performing the method of Example 21.

Embodiments may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a memory device;
a lock buffer coupled to the memory device; and
an atomic unit coupled to the lock buffer, wherein the atomic unit includes logic coupled to one or more substrates, the logic to:
detect a condition in which a plurality of atomic instructions target a common address and different bit positions in a mask,
generate a combined read-lock request for the plurality of atomic instructions in response to the condition, and
send the combined read-lock request to the lock buffer, wherein the memory device is associated with the common address.

2. The computing system of claim 1, wherein the logic is further to:
detect a response to the combined read-lock request,
combine an execution of the plurality of atomic instructions based on data in the response,
detect a completion of the combined execution of the plurality of atomic instructions,
generate a combined write-unlock request for the plurality of atomic instructions in response to the completion of the combined execution, and
send the combined write-unlock request to the lock buffer.

3. The computing system of claim 2, wherein the logic is further to:
generate a combined store-with-acknowledgement request for the plurality of atomic instructions if a result update requirement is associated with the plurality of atomic instructions, and
send the combined store-with-acknowledgement request to the lock buffer.

4. The computing system of claim 1, wherein the logic is further to:
detect a negative acknowledgement associated with the combined read-lock request, and
prioritize a retry of the combined read-lock request through a first in first out buffer.

5. The computing system of claim 1, wherein the memory device is a local memory device, the plurality of atomic instructions are to originate from a remote source in a distributed memory system, and the distributed memory system is to be a non-cached distributed memory system.

6. At least one computer readable storage medium comprising a set of executable program instructions, which when executed, cause a computing system to:
detect a condition in which a plurality of atomic instructions target a common address and different bit positions in a mask;
generate a combined read-lock request for the plurality of atomic instructions in response to the condition; and
send the combined read-lock request to a lock buffer coupled to a memory device associated with the common address.

7. The at least one computer readable storage medium of claim 6, wherein the executable program instructions, when executed, further cause the computing system to:
detect a response to the combined read-lock request; and
combine an execution of the plurality of atomic instructions based on data in the response.

8. The at least one computer readable storage medium of claim 7, wherein the executable program instructions, when executed, further cause the computing system to:
detect a completion of the combined execution of the plurality of atomic instructions;
generate a combined write-unlock request for the plurality of atomic instructions in response to the completion of the combined execution; and
send the combined write-unlock request to the lock buffer.

9. The at least one computer readable storage medium of claim 8, wherein the executable program instructions, when executed, further cause the computing system to:
generate a combined store-with-acknowledgement request for the plurality of atomic instructions if a result update requirement is associated with the plurality of atomic instructions; and
send the combined store-with-acknowledgement request to the lock buffer.

10. The at least one computer readable storage medium of claim 6, wherein the executable program instructions, when executed, further cause the computing system to:
detect a negative acknowledgement associated with the combined read-lock request; and
prioritize a retry of the combined read-lock request through a first in first out buffer.

11. The at least one computer readable storage medium of claim 6, wherein the memory device is to be a local memory device and the plurality of atomic instructions are to originate from a remote source in a distributed memory system.

12. The at least one computer readable storage medium of claim 11, wherein the distributed memory system is to be a non-cached distributed memory system.

13. A semiconductor apparatus comprising:
one or more substrates; and
logic coupled to the one or more substrates, wherein the logic is implemented at least partly in one or more of configurable or fixed-functionality hardware, the logic to:
detect a condition in which a plurality of atomic instructions target a common address and different bit positions in a mask;
generate a combined read-lock request for the plurality of atomic instructions in response to the condition; and
send the combined read-lock request to a lock buffer coupled to a memory device associated with the common address.

14. The semiconductor apparatus of claim 13, wherein the logic is further to:
detect a response to the combined read-lock request; and
combine an execution of the plurality of atomic instructions based on data in the response.

15. The semiconductor apparatus of claim 14, wherein the logic is further to:
detect a completion of the combined execution of the plurality of atomic instructions;
generate a combined write-unlock request for the plurality of atomic instructions in response to the completion of the combined execution; and
send the combined write-unlock request to the lock buffer.

16. The semiconductor apparatus of claim 15, wherein the logic is further to:
generate a combined store-with-acknowledgement request for the plurality of atomic instructions if a result update requirement is associated with the plurality of atomic instructions; and
send the combined store-with-acknowledgement request to the lock buffer.

17. The semiconductor apparatus of claim 13, wherein the logic is further to:
detect a negative acknowledgement associated with the combined read-lock request; and
prioritize a retry of the combined read-lock request through a first in first out buffer.

18. The semiconductor apparatus of claim 13, wherein the memory device is to be a local memory device and the plurality of atomic instructions are to originate from a remote source in a distributed memory system.

19. The semiconductor apparatus of claim 18, wherein the distributed memory system is to be a non-cached distributed memory system.

20. The semiconductor apparatus of claim 13, wherein the logic coupled to the one or more substrates includes transistor channel regions that are positioned within the one or more substrates.
